(19) United States
(12) Patent Application Publication
(10) Pub. No.: US 2010/0258142 A1
(43) Pub. Date: Oct. 14, 2010

(54) APPARATUS AND METHOD FOR USING A VISCOELASTIC CLEANING MATERIAL TO REMOVE PARTICLES ON A SUBSTRATE

(76) Inventors: Mark Naoshi Kawaguchi, Sunnyvale, CA (US); David Mui, Fremont, CA (US); Mark Wilcoxson, Oakland, CA (US)

Correspondence Address: MARTINE PENILLA & GENCARELLA, LLP, 710 LAKEWAY DRIVE, SUITE 200, SUNNYVALE, CA, 94085, US

(21) Appl. No.: 12/423,759

(22) Filed: Apr. 14, 2009

(51) Int. Cl. B08B 3/08; B08B 5/04; C25F 3/30

(52) U.S. Cl. 134/1.3; 134/27; 134/21

(57) ABSTRACT

The embodiments provide apparatus and methods for removing particles from a substrate surface, especially from a surface of a patterned substrate (or wafer). The cleaning apparatus and methods have advantages in cleaning patterned substrates with fine features without substantially damaging the features on the substrate surface. The cleaning apparatus and methods involve using a viscoelastic cleaning material containing a polymeric compound with large molecular weight, such as greater than 10,000 g/mol. The viscoelastic cleaning material entraps at least a portion of the particles on the substrate surface. The application of a force on the viscoelastic cleaning material over a sufficiently short period time causes the material to exhibit solid-like properties that facilitate removal of the viscoelastic cleaning material along with the entrapped particles. A number of forces can be applied over a short period to access the solid-like nature of the viscoelastic cleaning material. Alternatively, when the temperature of the viscoelastic cleaning material is lowered, the visoelastic cleaning material also exhibits solid-like properties.

### CROSS REFERENCE TO RELATED APPLICATIONS

This application is related to U.S. patent application Ser. No. 12/131,654, filed on Jun. 2, 2008, and entitled “Materials for Particle Removal by Single-Phase and Two-Phase Media,” and U.S. patent application Ser. No. 12/401,590, filed on Mar. 10, 2009, and entitled “Method of Particle Contaminant Removal.” The disclosure of each of these related applications is incorporated herein by reference for all purposes. This application is also related to U.S. patent application Ser. No. ______ (Atty. Docket No. LAM2P655), filed on ______, and entitled “Method of Particle Contaminant Removal.”

### BACKGROUND

In the fabrication of semiconductor devices such as integrated circuits, memory cells, and the like, a series of manufacturing operations are performed to define features on semiconductor wafers (“wafers”). The wafers (or substrates) include integrated circuit devices in the form of multi-level structures defined on a silicon substrate. At a substrate level, transistor devices with diffusion regions are formed. In subsequent levels, interconnect metallization lines are patterned and electrically connected to the transistor devices to define a desired integrated circuit device. Also, patterned conductive layers are insulated from other conductive layers by dielectric materials.

During the series of manufacturing operations, the wafer surface is exposed to various types of contaminants. Essentially any material present in a manufacturing operation is a potential source of contamination. For example, sources of contamination may include process gases, chemicals, deposition materials, and liquids, among others. The various contaminants may deposit on the wafer surface in particulate form. If the particulate contamination is not removed, the devices within the vicinity of the contamination will likely be inoperable. Thus, it is necessary to clean contaminants from the wafer surface in a substantially complete manner without damaging the features defined on the wafer. However, the size of particulate contamination is often on the order of the critical dimension size of features fabricated on the wafer. Removal of such small particulate contamination without adversely affecting the features on the wafer can be quite difficult. Conventional wafer cleaning methods have relied heavily on mechanical force to remove particulate contamination from the wafer surface. As feature sizes continue to decrease and become more fragile, the probability of feature damage due to application of mechanical forces on the wafer surface increases. For example, features having high aspect ratios are vulnerable to toppling or breaking when impacted by a sufficient mechanical force. To further complicate the cleaning problem, the move toward reduced feature sizes also causes a reduction in the size of particulate contamination. The force necessary to overcome the adhesion between particulate contaminants and the substrate surface increases with smaller particles because of the higher surface-to-volume ratio. Thus, efficient and non-damaging removal of contaminants during modern semiconductor fabrication represents a continuing challenge to be met by continuing advances in wafer cleaning technology. It should be appreciated that the manufacturing operations for flat panel displays suffer from the same shortcomings of the integrated circuit manufacturing discussed above.

In view of the forgoing, there is a need for apparatus and methods of cleaning patterned wafers that are effective in removing contaminants and do not damage the features on the patterned wafers.

### SUMMARY

Broadly speaking, the embodiments of the present invention provide apparatus and methods for removing particles from a substrate surface, especially from a surface of a patterned substrate (or wafer). The cleaning apparatus and methods have advantages in cleaning patterned substrates with fine features without substantially damaging the features on the substrate surface. The cleaning apparatus and methods involve using a viscoelastic cleaning material containing a polymeric compound with large molecular weight, such as greater than 10,000 g/mol. The viscoelastic cleaning material entraps at least a portion of the particles on the substrate surface. The application of a force on the viscoelastic cleaning material over a sufficiently short period time causes the material to exhibit solid-like properties that facilitate removal of the viscoelastic cleaning material along with the entrapped particles. A number of forces can be applied over a short period to access the solid-like nature of the viscoelastic cleaning material. Alternatively, when the temperature of the viscoelastic cleaning material is lowered, the visoelastic cleaning material also exhibits solid-like properties.

Various embodiments of apparatus and methods are described in the current application to illustrate how particles on a substrate surface can be removed without damaging the features on the substrate surface. It should be appreciated that the present invention can be implemented in numerous ways, including as a system, a method and a chamber. Several inventive embodiments of the present invention are described below.

In one embodiment, a method of removing particles from a surface of a substrate is provided. The method includes dispensing a layer of a cleaning material on the surface of the substrate. The substrate is rotated by a substrate support, and wherein the cleaning material is a viscoelastic solution, which includes a polymeric compound. The polymeric compound is soluble in a cleaning solution to form the cleaning material. The cleaning material captures and entraps at least some of the particles from the surface of the substrate. In addition, the method includes dispensing a rinsing liquid on the layer of the cleaning material on the surface of the substrate to remove the layer of cleaning material. An energy is applied on the cleaning material during or prior to dispensing the rinsing liquid on the layer of the cleaning material. The energy applied increases (or enhances) a solid-like response of the cleaning material to facilitate removal of the cleaning material from the substrate surface. At least some of the particles that are entrapped by the cleaning material are removed along with the cleaning material.

In another embodiment, a method of removing particles from a surface of a substrate is provided. The method includes dispensing a layer of a viscoelastic cleaning material on the surface of the substrate. The substrate is rotated by a substrate support. The viscoelastic cleaning material captures and entraps at least some of the particles from the surface of the substrate. The method also includes dispensing a rinsing liquid on the layer of the cleaning material on the surface of the substrate to remove the layer of cleaning material. An energy is applied on the cleaning material during or prior to dispensing the rinse liquid on the layer of the cleaning material. The energy applied increases (or enhances) a solid-like response of the cleaning material to facilitate removal of the cleaning material from the substrate surface. At least some of the particles that are entrapped by the cleaning material are removed along with the cleaning material.

In yet another embodiment, a method of removing particles from a surface of a substrate in an apparatus having a number of processing slots is provided. The method includes moving the substrate to a first processing slot of the apparatus by a substrate support. The first processing slot of the apparatus is separated from the processing slots below the first processing slot by the substrate support. The method also includes dispensing a layer of a viscoelastic cleaning material on the surface of the substrate. The substrate is rotated by a substrate support. The viscoelastic cleaning material captures and entraps at least some of the particles from the surface of the substrate.

The method further includes moving the substrate to a second processing slot of the apparatus by the substrate support. The second processing slot of the apparatus is separated from the processing slots below the second processing slot by the substrate support. In addition, the method includes dispensing a rinsing liquid on the layer of the cleaning material on the surface of the substrate to remove the layer of the viscoelastic cleaning material. Energy is applied on the cleaning material during or prior to dispensing the rinse liquid on the layer of the cleaning material. The energy applied enhances a solid-like response of the cleaning material to facilitate removal of the cleaning material from the substrate surface. The at least some of the particles that are entrapped by the cleaning material are removed along with the cleaning material.

### BRIEF DESCRIPTION OF THE DRAWINGS

The present invention will be readily understood by the following detailed description in conjunction with the accompanying drawings, and like reference numerals designate like structural elements.

FIG. 1 shows a viscoelastic cleaning material containing polymers of a polymeric compound with large molecular weight dispensed on a substrate surface to clean contaminants on the substrate surface, in accordance with one embodiment of the present invention.

FIG. 2A shows an apparatus for dispensing a viscoelastic cleaning material, in accordance with one embodiment of the present invention.

FIG. 2B shows a top view of the apparatus shown in FIG. 2A, in accordance with one embodiment of the present invention.

FIG. 2C shows a substrate being held steady by a pair of rollers, in accordance with one embodiment of the present invention.

FIG. 3A shows an apparatus for dispensing a rinsing liquid on the substrate surface, in accordance with one embodiment of the present invention.

FIG. 3B shows a stream of rinse liquid being dispensed on a film of cleaning material, in accordance with one embodiment of the present invention.

FIG. 3C shows an enlarged view of region A of FIG. 3B, in accordance with one embodiment of the present invention.

FIG. 3D shows a portion of substrate after a part of cleaning material in region B of FIG. 3C having been removed by the rinse liquid, in accordance with one embodiment of the present invention.

FIG. 3E shows a process flow of removing particles from a substrate, in accordance with one embodiment of the present invention.

FIG. 4 shows an integrated processing apparatus for removing particles from a substrate surface, in accordance with one embodiment of the present invention.

FIG. 5A shows an apparatus similar to the apparatus of FIG. 3B with backside cooling, in accordance with one embodiment of the present invention.

FIG. 5B show a process flow of removal particles from a surface of a substrate, in accordance with one embodiment of the present invention.

FIG. 6A shows an apparatus having a suction tube attached to a handle, in accordance with one embodiment of the present invention.

FIG. 6B shows a suction head coupled to a handle, in accordance with one embodiment of the present invention.

FIG. 6C shows a button view of suction head of FIG. 6B with suction holes, in accordance with one embodiment of the present invention.

FIG. 6D shows a process flow for removing particles from a substrate surface, in accordance with one embodiment of the present invention.

FIG. 7A shows a acoustic resonator block that is placed above a substrate, in accordance with one embodiment of the present invention.

FIG. 7B shows acoustic resonator blocks placed above and below a substrate, in accordance with one embodiment of the present invention.

FIG. 7C shows a cleaning material rinsing system, in accordance with one embodiment of the present invention.

FIG. 7D is a side view of a rinse head, in accordance with one embodiment of the present invention.

FIG. 7E shows a top view of a rinse head over a substrate, in accordance with one embodiment of the present invention.

FIG. 7F shows a process flow for removing particles from a substrate surface, in accordance with one embodiment of the present invention.

FIG. 8 shows a process flow for removing particles from a substrate surface, in accordance with one embodiment of the present invention.

FIG. 9A shows a spray jet head for introducing a rinsing liquid, in accordance with one embodiment of the current invention.

FIG. 9B shows an apparatus for applying a spray jet of rinsing liquid, in accordance with one embodiment of the present invention.

FIG. 9C shows a process flow of cleaning a substrate, in accordance with one embodiment of the present invention.

FIG. 10 shows a process flow for removing particles from a substrate surface, in accordance with one embodiment of the present invention.

FIG. 11A show a top view of a substrate under oscillation of degree A, in accordance with one embodiment of the present invention.

FIG. 11B shows a process flow for removing particles from a substrate surface, in accordance with one embodiment of the present invention.

### DETAILED DESCRIPTION

Embodiments of materials, methods and apparatus for cleaning wafer surfaces without damaging surface features are described. The cleaning materials, apparatus, and methods discussed herein have advantages in cleaning patterned substrates with fine features without damaging the features. The cleaning materials are fluidic, either in liquid phase, or in liquid/gas phase, and deform around device features; therefore, the cleaning materials do not damage the device features. The cleaning materials, containing a polymeric compound with large molecular weight, such as greater than 10,000 g/mol, capture the contaminants on the substrate. In addition, the cleaning materials entrap the contaminants and do not return the contaminants to the substrate surface. The large molecular weight of the polymer chains enhances the capture and entrapment of particulate contaminants relative to conventional cleaning materials.

It will be obvious, however, to one skilled in the art, that the present invention may be practiced without some or all of these specific details. In other instances, well known process operations have not been described in detail in order not to unnecessarily obscure the present invention.

The embodiments described herein provide cleaning apparatus and cleaning methods that are effective in removing contaminants and do not damage the features on the patterned wafers, some of which may contain high aspect ratio features. While the embodiments provide specific examples related to semiconductor cleaning applications, these cleaning applications might be extended to any technology requiring the removal of contaminants from a substrate.

For advanced technologies, such as 65 nm, 45 nm, 32 nm, 22 nm, and, 16 nm technology nodes and below, the smallest features have widths that are about the sizes of the respective nodes. The widths of device structures are scaled continuously down with each technology node to fit more devices on the limited surface area of chips. The heights of the device structures, such as height of device structure, in general do not scale down proportionally with the width of the device features due to concern of resistivities. For conductive structures, such as polysilicon lines and metal interconnect, narrowing the widths and heights of structures would increase the resistivities too high to cause significant RC delay and generate too much heat for the conductive structures. As a result, device structures, such as structure, would have high aspect ratio, which make them prone to damage by force applied on the structure. In one embodiment, the aspect ratio of the device structure can be in the range of about 2 or greater. The force applied on the structure includes force used to assist in removing particles (or contaminants) from substrate surface, which can be a result of any relative motion between the cleaning material and the substrate surface or can be from dispensing of cleaning material or rinsing liquid on the substrate surface.

The decreased widths of device structures and the relatively high aspect ratios of device structures make the device structures prone to breakage under applied force or accumulated energy under applied force. The damaged device structures can become inoperable due to the damage and reduced overall yield.

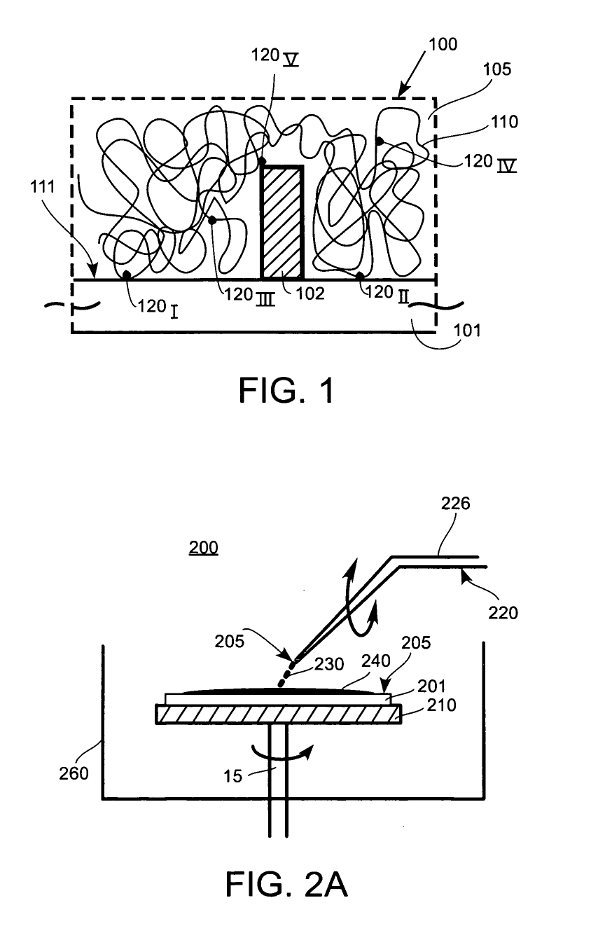

FIG. 1 shows a viscoelastic cleaning material 100, which contains a liquid cleaning solution 105 and polymers 110 with large molecular weight dissolved in the cleaning liquid 105, in accordance with one embodiment of the present invention. In one embodiment, the cleaning material 100 is in liquid form. In another embodiment, the cleaning material 100 is a gel or a sol. The cleaning material 100, when applied on a substrate 101 with particles on the substrate surface 111, can capture and remove particles, such as particles 120_{I}, 120_{II}, from the substrate surface 111 of substrate 101 by at least partial binding or interacting with the particles. In addition, the cleaning material 100 entraps particles that are removed from the substrate surface 111, such as particles 120_{I}, 120_{II}, particles on the surfaces of features, such as particle 120_{V} on feature 102, or are present in the cleaning material 100, such as particles 120_{III}, 120_{IV}, to prevent them from falling or depositing on the substrate surface 111 also by at least partial binding or interacting with the particles. Particles on the surfaces of features, such as particle 120_{V} on feature 102, can be on the sidewalls of the features (not shown). Details of a cleaning material containing polymers with a large molecular weight have been described in commonly assigned U.S. patent application Ser. No. 12/131,654, filed on Jun. 2, 2008, and entitled “Materials for Particle Removal by Single-Phase and Two-Phase Media,” which is incorporated herein by reference in its entirety.

To enable capturing particles, such as particles 120_{I}, 120_{II} on the substrate surface 111 to remove them from the substrate surface 111, the polymers 110 need to come in proximity with the particles, such as particles 120_{I}, 120_{II} on the substrate surface 111. If the net attractive forces between the polymers 110 and the particles 120_{I}, 120_{II} are stronger than the forces between the particles and the substrate surface 111, the polymers 110 in the cleaning material 100 displace the particles 120_{I}, 120_{II}, away from the substrate surface 111.

In one embodiment, the cleaning material 100, which is a solution with polymer(s) exhibits viscoelastic properties. After the cleaning material 100 is applied on the substrate surface 111 and comes in contact with the particles, the cleaning material 100 and the particles needs to be removed from the substrate surface 111. There are several ways to remove the cleaning material 100 from the substrate surface 111. For example, a force can be applied on the cleaning material 100 to remove it from the substrate surface 111. Depending on the applied force and the time scale of the applied force, the viscoelastic cleaning material has either a liquid-like response or a solid-like response. If the time scale of the applied force is shorter than the characteristic time scale of the viscoelastic cleaning material, it will exhibit a solid-like response. The viscoelastic cleaning material behaves like a solid and does not flow like a liquid. A “solid-like” viscoelastic cleaning material can be rigid and unyielding, like an amorphous crystalline substance, or can deform like a rubber (elastic-like) or metal.

The characteristic time of the viscoelastic cleaning material is a response time (or characteristic response time) for the viscoelastic cleaning material to response to an external energy, such as a force, a stress, or an exposure to high or low temperature (heating or cooling), being applied on the material. The external energy being applied is temporarily stored at the location(s) being exposed to the external energy and it takes a certain amount of time (i.e. a characteristic response time) for the viscoelastic cleaning material to respond to the applied external energy or for viscoelastic cleaning material to dissipate the external energy. When the time scale of the applied external force or external energy is shorter than the characteristic response time, the viscoelastic cleaning material does not have sufficient time to respond to the external force or external energy being applied. The viscoelastic cleaning material would behave like a solid.

In contrast, if the time scale of the applied force is longer than the characteristic time scale of the viscoelastic cleaning material, it will exhibit a liquid-like response. The viscoelastic cleaning material would flow like a liquid. Examples of applying forces at relatively short time scales include, but are not limited to, applying a shearing flow tangential to the viscoelastic material which is contact with the substrate, a suction flow normal to the viscoelastic material, an impinging flow normal to the viscoelastic material such as a spray jet, or an acoustical force coupled directly to the viscoelastic material or indirectly through a medium such as a gas, liquid or solid such as the substrate itself, or a mechanically-induced oscillatory flow.

The magnitude of the solid-like response typically increases by applying forces at even shorter time scales. The characteristic time scale of the viscoelastic cleaning material can be adjusted by a variety of ways, such as changing the concentration or chemical or structural nature of the polymeric compound, and the concentration or chemical or structural nature of the cleaning solution which solubilizes the polymeric compound. Furthermore, the characteristic time of the viscoelastic cleaning material can be decreased by lowering the temperature of the viscoelastic cleaning material or increased by raising the temperature of the viscoelastic cleaning material. The viscoelastic cleaning material can be cooled in conjunction with an applied force to more readily access the solid-like nature of the material. Even further, the characteristic time of the viscoelastic cleaning material and the magnitude of the solid-like response can be changed by adjusting the concentration of the polymeric component. A high concentration of the polymeric component within the viscoelastic cleaning material in conjunction with an applied force more readily accesses the solid-like nature of the material.

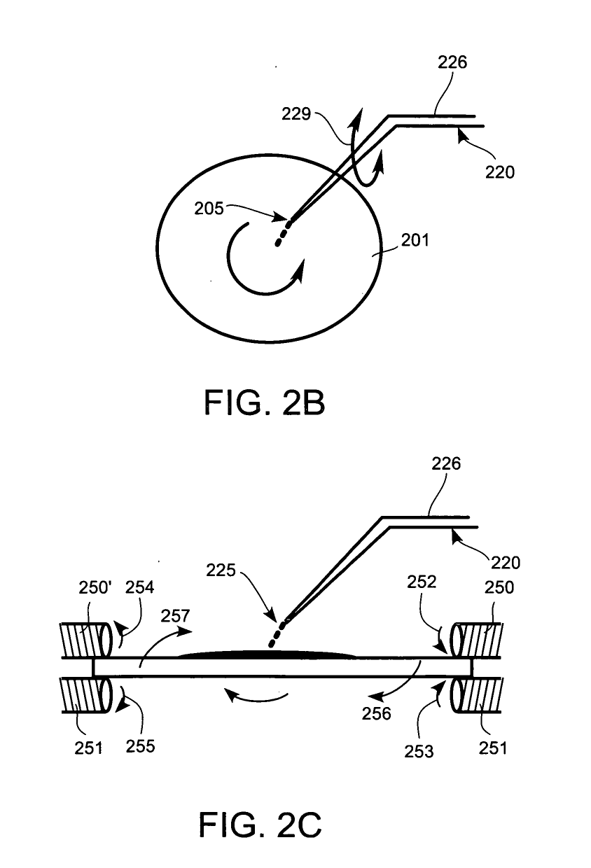

There are many ways to apply the cleaning material 100 on a substrate to remove particles from the surface of the substrate 101, as shown in FIG. 1. In one embodiment, the cleaning material is dispensed on a substrate while the substrate is rotated around its center. After the cleaning material is dispensed on the substrate, the cleaning material captures and entraps particles on the substrate surface by at least partial binding or interaction with the particles. FIG. 2A shows an embodiment of an apparatus 200 for dispensing a viscoelastic cleaning material 230, which is similar to cleaning material 100 described above, on the substrate surface. The substrate 201 is disposed on a substrate support 210. In one embodiment, the substrate support 210 is a vacuum chuck, which secure the substrate 201 by vacuum. The substrate support 210 is coupled to an axle 215 near the center of the substrate support 210. The axle 215 is rotated by a mechanic device (not shown). There is a container 260 surrounding the substrate support 210 and substrate 201 to catch the excess (or overflow) cleaning material. Above the substrate 201 and substrate support 210, there is a cleaning material dispenser 220, which dispenses cleaning material 230 on the substrate surface 205. The cleaning material 230 forms a thin film 240 on the substrate surface 205. In one embodiment, the nozzle 225 of the cleaning material dispenser 220 points to the center of surface 205 of the substrate 201. In one embodiment, the substrate is rotating at a speed between about 0 to about 1000 rpm (round per minute). In another embodiment, the rotation speed is between about 0 to about 500 rpm. In yet another embodiment, the rotation speed is between about 50 to about 300 rpm.

In one embodiment, the arm 226 of the cleaning material dispenser 220 sweeps across the surface 205 of the substrate 201. FIG. 2B shows a top view of the apparatus 200, in accordance with one embodiment of the present invention. In the embodiment shown in FIG. 2B, the arm 226 sweeps across the surface of the substrate 201 along the arc 229. When the arm 226 sweeps across the substrate 201, the substrate 201 rotates around its center. Due to the rotation of the substrate 210 and the sweeping of the arm 226, the cleaning material is dispensed over the entire substrate surface. In one embodiment, the speed of sweeping (or swing) of the arm 226 is between about 0 rpm to about 1000 rpm. In another embodiment, the speed of the sweeping is between about 0 rpm to about 300 rpm. In yet another embodiment, the speed of the sweeping is between about 10 rpm to about 100 rpm.

In one embodiment, the time it takes to dispense a film of the cleaning material on the substrate is between about 10 seconds to about 120 seconds. In another embodiment, the time it takes to dispense a film of the cleaning material is between about 10 seconds to about 60 seconds. In yet another embodiment, the time it takes to dispense a film of the cleaning material on the substrate surface is between about 20 seconds to about 40 seconds.

In one embodiment, the flow rate of the cleaning material from the dispense nozzle 225 is between about 0 ml/min to about 1000 mil/min. In another embodiment, the flow of the cleaning material is between about 25 ml/min to about 500 ml/min. In yet another embodiment, the flow of the cleaning material is between about 50 ml/min to about 300 ml/min.

If the arm 226 stays stationary to dispense the cleaning material only at the center of substrate 201, the cleaning material can be spread across the entire surface 205 of the substrate 201 by the rotation of the substrate and the fluidity of the cleaning material.

The cleaning material can be dispensed on the front side (device side) of the substrate, backside of the substrate, or both sides of the substrate to remove particles on the surface(s) of the substrate.

To dispense the fluidic cleaning material on a spinning substrate, the substrate does not need to be disposed on a substrate support, such as substrate support 210 of FIG. 2A. The substrate can be held by rollers, grippers, pins, or other types of substrate securing devices. FIG. 2C shows an embodiment of a substrate 201′ being held steady by a pair of rollers, 250, 251, and 250′ and 251′. The substrate 201′ is rotated by the rotating motion of the rollers. Roller 250 rotates in the circular direction 252 (counter clockwise), while roller 251 rotates in the circular direction 253 (clockwise) to push the edge of substrate 201′ between these two rollers in the direction 256 (pointing out the paper). Roller 250′ rotates in the circular direction 254 (clockwise), while roller 251′ rotates in the circular direction 255 (counter clockwise) to push the edge of substrate between these rollers in the direction 257 (pointing into the paper). The rollers 250, 251, 250′, and 251′ move the substrate 201′ to rotate clock-wisely.

The embodiments of methods and apparatus described in the current invention involve utilizing the viscoelastic nature of the cleaning material. As mentioned above, when an external force is applied at a sufficiently fast rate, the viscoelastic cleaning material exhibits a solid-like response that facilitates removal of the viscoelastic cleaning material with the entrapped particulate contaminants from the substrate surface. Cooling the viscoleastic cleaning material in conjunction with an applied force more readily accesses the solid-like response.

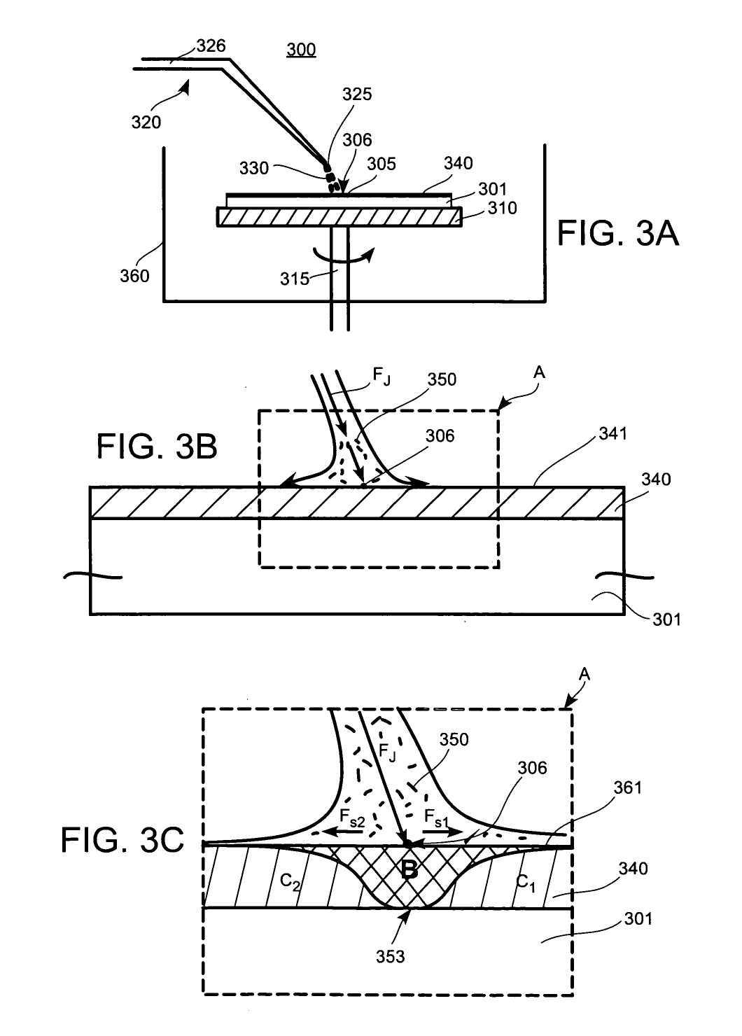

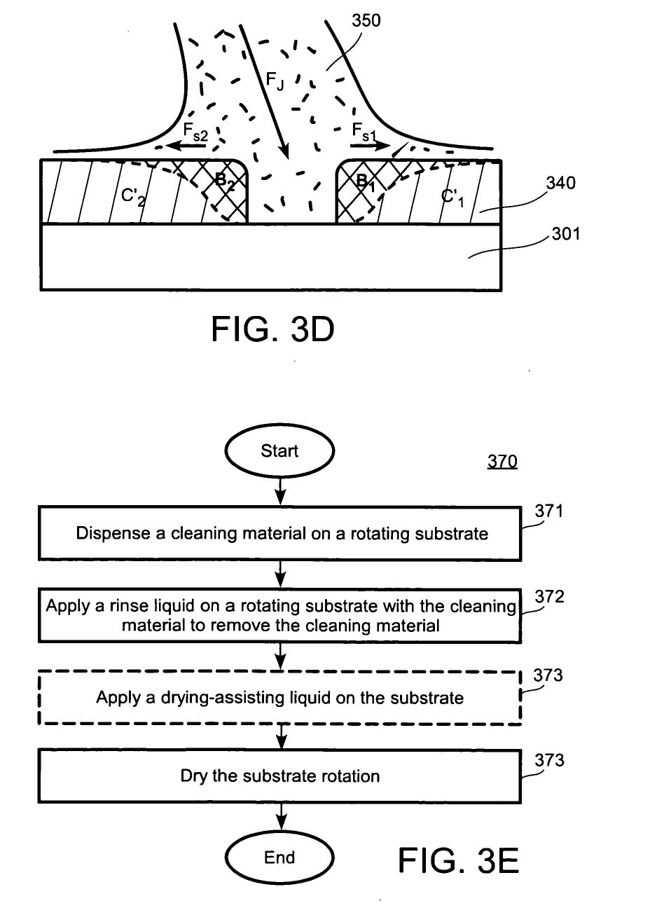

FIG. 3A shows an apparatus 300 for dispensing a rinsing liquid 330 on the substrate surface, in accordance with one embodiment of the present invention. The substrate 301 is disposed on a substrate support 310. In one embodiment, the substrate support 310 is a vacuum chuck, which secures the substrate 301 by vacuum. The substrate support 310 is coupled to an axle 315 near the center of the substrate support 310. The axle 315 is rotated by a mechanic device (not shown). Above the substrate 301 and substrate support 310, there is a rinse liquid dispenser 320, which dispenses rinse liquid 330 on the surface 305 of substrate 301, which has a thin film 340 of the cleaning material. The rinse liquid can be de-ionized water (DIW), gasified water (or DIW) with gas(es), such as N2, CO₂, or air, deoxygenated DIW, DIW with additives, such as surfactant, corrosion inhibitors, or chelating agents. Alternatively, rinse liquids can also include aqueous based chemistries, such as APM (ammonium peroxide mixture, also called SC1), SC-2 (standard clean-2, main chemical is HCl), HF, H₂SO₄, NH₄OH, SPM (sulfuric-acid peroxide mixture), H₂O₂, and DSP (diluted sulfuric-acid peroxide mixture), etc.

In one embodiment, the nozzle 325 of the cleaning material dispenser 320 points to the center of surface 306. There is a container 360 surrounding the substrate support 310 and substrate 301 to catch the excess (or overflow) rinse liquid and removed cleaning material along with removed particles. In one embodiment, substrate support 310 is substrate support 210 of FIG. 2A, which means that the substrate 201 stays on the substrate support 210 after the cleaning material dispensing operation to be applied with rinse liquid in the same apparatus. In such an embodiment, the apparatus 200 has another arm for applying rinse liquid.

The substrate is rotating at a speed between about 0 rpm to about 1000 rpm (round per minute) during rinsing operation. In another embodiment, the rotation speed is between about 0 rpm to about 500 rpm. In yet another embodiment, the rotation speed is between about 50 rpm to about 300 rpm. In one embodiment, the arm 326 of the cleaning material dispenser 320 sweeps across the surface 305 of the cleaning material 301 in a manner similar to the arm 226 of FIG. 2A. In one embodiment, the flow rate of the cleaning material from the dispense nozzle 325 is between about 0 to about 1000 ml/min. In another embodiment, the flow of the cleaning material is between about 0 to about 500 ml/min. In yet another embodiment, the flow of the cleaning material is between about 50 to about 300 ml/min.

FIG. 3B shows a stream of rinse liquid 350, such as de-ionized water (DIW), being dispensed on a film of cleaning material 340, in accordance with one embodiment of the present invention. The stream of rinse liquid 350 is introduced on the substrate surface while the substrate is being rotated. The rinse liquid 450 applies a force, F_{J}, on the surface of the cleaning material in a region surrounding the point 306. FIG. 3C shows an enlarged view of region A of FIG. 3B, in accordance with one embodiment of the present invention. The rinse liquid 350, after hitting the surface of the cleaning material, flows along the surface 341 of the cleaning material 340 and introduces F_{S1} on right side of point 306 and F_{S2} on left side of point 306. The forces introduced by F_{J}, F_{S1}, and F_{S2} make a region B surrounding point 351 of cleaning material 340 “solid-like” (or close to solid-like).

Other regions of the cleaning material 340, such as regions C1 and C2, do not directly exhibit solid-like properties. The forces introduced by F_{J}, F_{S1}, and F_{S2} induce a liquid-like response to flow the material as if it is displaced by region B. The cleaning material in region B is solid-like. Removing a solid-like cleaning material from the interface 353 between region B and the substrate 401 (solid-to-solid) increases the efficiency of particle removal from the substrate surface.

The cleaning material 340 in region B is easily lifted off the surface 411 of substrate 301. The force of the rinse liquid activates the solid-like response and transfers the energy necessary to lift-off the cleaning material and entrapped particulate contaminants from the surface 341 of substrate 310. After part of the cleaning material lifts off from the substrate surface, the rinse liquid 350 continues to exert forces on the cleaning material to remove it from the substrate surface. FIG. 3D shows an embodiment of a portion of substrate 301 after a part of cleaning material in region B of FIG. 3C having been removed by the rinse liquid 350. The region B only has region B1 on the right side and B2 on the left side remaining. Since the rinse liquid 350 continues to exert forces F_{J}, F_{S1}, and F_{S2} on the cleaning material 340, the forces continues to expand the “solid-like” region B1 on the right and to shrink region C1 to C1′. On the left side, the “solid-like” area expands to region B2, while C2 shrinks to C2′. As the rinse liquid continues to apply forces on the cleaning material 340, the “solid-like” cleaning material, which includes regions B1, B2, would be removed from the substrate surface. In this manner, the cleaning material is removed from the substrate surface. When the cleaning material is removed form the substrate surface, the particles on the substrate surface are removed from the substrate surface along with the cleaning material. As mentioned above, the particles are captured and entrapped in the cleaning material.

After the rinse liquid 350 removes the cleaning material 340 from the substrate surface. In one embodiment, there is an additional drying operation by rotation to spin off all the rinse liquid from the substrate surface. The substrate can stay on substrate support 310 to be rotated by the same mechanism as shown in FIG. 3A. In another embodiment, the substrate can be moved to a separate rotation system or chamber to perform the drying by rotation operation. During drying by rotation operation, in one embodiment, the rotation speed is between about 100 rpm to about 5000 rpm. In another embodiment, the rotation speed is between about 500 rpm to about 3000 rpm. In yet another embodiment, the rotation speed is between about 1000 rpm to about 2500 rpm. In one embodiment, the duration for the drying rotation is between about 10 seconds to about 90 seconds. In another embodiment, the rotation duration is between about 20 seconds to about 60 seconds. In yet another embodiment, the rotation duration is between about 30 seconds to about 60 seconds. Alternatively the drying operation can be assisted by applying a dry-assisting liquid, such as liquid isopropyl alcohol (IPA), a mixture of IPA and water, a dry-assisting vapor, such as vapor phase IPA, or a mixture of a dry-assisting vapor and one or more inert gas(es). For example, the one or more inert gas(es) can be N₂, O₂, Ar, air, or He.

Examples of the methods and apparatus for removal particles on a substrate, which can be patterned or blank, utilizing the viscoelastic nature of the cleaning material are described below:

### Method 1:

As mentioned above, the viscoelastic cleaning material is dispensed on a substrate while the substrate is rotated around its center. When the cleaning material is dispensed on the substrate, the cleaning material captures and entraps particles on the substrate surface by at least partial binding or interaction with the particles. The dispensing of the cleaning material results in a uniform film of cleaning material on the surface 305 of the substrate 301. The control of the rotation speed of the substrate and the flow rate of the cleaning material enables coating the cleaning material on the substrate surface to be uniform and to be thin. For example, the film thickness can be as thin as about 500 angstroms. Thin film of the cleaning material allows the concentration of the viscoelastic component (polymers) to be increased due to the evaporation of the cleaning solution. The evaporation rate of the volatile components in the cleaning solution can be adjusted to affect the concentration of the viscoelastic component. Increasing the concentration of the viscoelastic component of the cleaning material increases the solid-like nature of the cleaning material, which facilitates removal of the cleaning material with the entrapped particles from the substrate surface. Depositing a very thin film of cleaning material on a substrate surface to increase the viscoelastic component of the cleaning material by evaporation allows a simpler design of the cleaning material dispensing system. The design of the cleaning material dispensing system with a high concentration of the polymeric component is more complex due to the high viscosity of the cleaning material.

The cleaning material can be removed from the substrate surface by a rinse liquid, which could be dispensed on the substrate surface while the substrate is rotated around its center. While the rinse liquid is being applied on the cleaning material, it can assert an external force on the cleaning material to further increase the elastic nature of the film.

FIG. 3E shows a process flow 370 of removing particles from a substrate, in accordance with one embodiment of the present invention. At operation 371, a viscoelastic cleaning material is applied on a substrate that is rotating. As mentioned above, the dispense arm can be sweeping across the substrate surface. After the cleaning material is dispensed on the substrate, at operation 372, a rinse liquid is applied on the substrate under rotation. As discussed above, during this operation, the force applied by the rinse liquid make the cleaning material “solid-like”, which facilitates removal of the cleaning material with the entrapped particles from the substrate surface. Afterwards, at operation 374, the substrate is dried by rotation. In one embodiment, a drying-assisting liquid, such as liquid isopropyl alcohol (IPA) or a mixture of IPA and water or a dry-assisting vapor, such as vapor phase IPA or a mixture of vapor phase IPA and N₂ gas, is applied on the substrate at an optional operation 373, prior to operation 374.

The embodiment of method discussed above involves applying cleaning material, rinsing liquid, drying, and optionally a drying-assisting liquid are all performed on spinning apparatus. The spinning apparatus for applying cleaning material, such as the apparatus of FIG. 2A, and the apparatus for applying rinsing liquid, such as the apparatus of FIG. 3A, to remove the cleaning material from substrate surface are separate apparatus. The spin dry apparatus for operations 373 and 374 discussed above are also similar to the apparatus of FIGS. 2A and 3A. In the embodiments of process flow 370 described above, the substrate can be moved from apparatus 200 (for dispensing cleaning material) to apparatus 300 (for dispensing rinsing liquid), to another drying apparatus (similar to apparatus 200 and 300), or performing the dispensing cleaning material, dispensing rinsing liquid, and drying in one single apparatus. Applying different process operations of process flow 370 in different apparatus allow the waste to be reclaimed more easily. However, moving the substrate from apparatus to apparatus is more time and space consuming. On the other hand, performing the various process operations of process flow 370 in one single apparatus make waste reclaim more complicated.

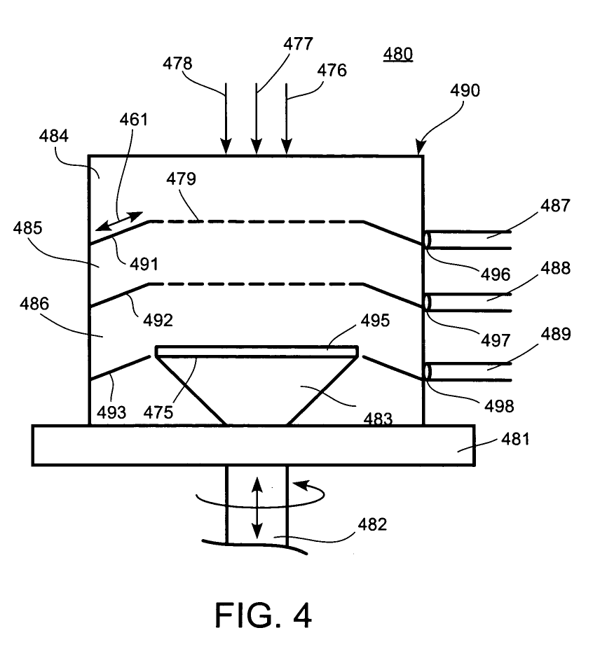

FIG. 4 shows an embodiment of an integrated processing apparatus 480 for removing particles from a substrate surface. In one embodiment, the entire process flow 470 can be performed with the integrated processing apparatus 480. Apparatus 480 has a process chamber 490, which is on top of a chamber support 481. The process chamber 490 has a number of processing slots, such as slots 484, 485, and 486. The axle 482 is coupled to a substrate support 483 (or a chuck). The axle 482 is configured to rotate the substrate support 483, and to move the substrate support 483 up and down to place the substrate 495 in different processing slots. The different processing slots are separated by angled rings, such as angled rings 491, 492, and 493. The angled rings 491, 492, and 493 are angled to allow the excess fluid, such as cleaning material, rinse liquid and drying-assisting liquid in different slots, to flow away from the substrate 495 and the exposed surface of the substrate support 483. At the lowest position of each processing slot, there is an exhaust opening, such as exhaust opening 496, 497, and 498. The exhaust openings 496, 497, and 498, are coupled to exhaust pipes 487, 488, and 489 respectively to exhaust reclaim systems (not shown).

During substrate cleaning, the substrate is moved from one processing slot for one operation to another processing slot for another operation. For example, substrate 495 is moved to slot 484 by axle 482 to receive the cleaning material, which is applied from through a cleaning material supply line 476. In one embodiment, the top surface 475 of the substrate support 483 is moved the level of dotted line 479 and the edge of substrate support 483 substantially touch with the edge of the angled ring 491 to make processing slot 484 separate from processing slot 485 below. The close contact between the edge of the substrate support 483 and the edge of the angled ring 491 prevent the cleaning material from leaking to the processing slots 485 and 486 below. In one embodiment, the angled ring 491 can move in the direction 461 to open or close the angled ring 491, which allows the substrate support 483 to move freely and also allow the angled ring 491 to come in close contact with the substrate support 483. Other angled rings, 492, 493 can also move in a similar manners as angled ring 491. The substrate support 483 can also move the substrate 495 to be processed in processing slots 485 and 486 in similar manners.

In one embodiment, after the substrate 495 is deposited with the cleaning material, the substrate is moved to processing slot 485 to receive rinsing liquid, which can be supplied through supply line 477, to remove the cleaning material and particles on the substrate surface. Afterward, the substrate 495 can be moved processing slot 486 for drying. Drying-assisting liquid can be applied through supply line 478. As mentioned above, the substrate 495 spins (or rotates) during the various processing operations with the assistance of the substrate support 483 and spinning axle 482.

### Method 2:

As mentioned above, when the temperature of a viscoelastic material (or viscoelastic solution) is reduced, the solid-like nature of the material is increased. Lowering the temperature increases the characteristic time of the viscoleastic material. With the increase in the solid-like response, the force applied by the rinsing liquid can be reduced, which reduces the risk of damaging the device features on the substrate surface. The degree of cooling of the cleaning material to increase the solid-like property depends on the specific nature of the viscoelastic cleaning material. In one embodiment, the temperature of the cleaning material is at a temperature between about 0° C. to about 50° C. In another embodiment, the temperature of the cleaning material is between about 0° C. to about 30° C. In yet another embodiment, the temperature of the cleaning material is between about 10° C.-20° C.

The apparatus and methods for substrate cleaning of method 2 described here are similar to those for method 1, with the exception of lowering the temperature of the cleaning material during the rinsing operation. In one embodiment, the temperature of the cleaning material is lowered by cooling the substrate support, similar to substrate support 310 of FIG. 3A. When the substrate support is cooled, the substrate 301 and the cleaning material on the substrate 340 are also cooled. In one embodiment, the substrate support, similar to substrate support 310, is embedded with cooling tubes, which runs a cooling liquid. Alternatively, the backside of the substrate support, similar to substrate support 310, or the backside of substrate, similar to substrate 201′ of FIG. 2B, is sprayed with a cooling liquid lower the temperature of the substrate and the temperature of the cleaning material. Examples of cooling liquid include low-temperature water, and alcohols with low evaporation temperatures.

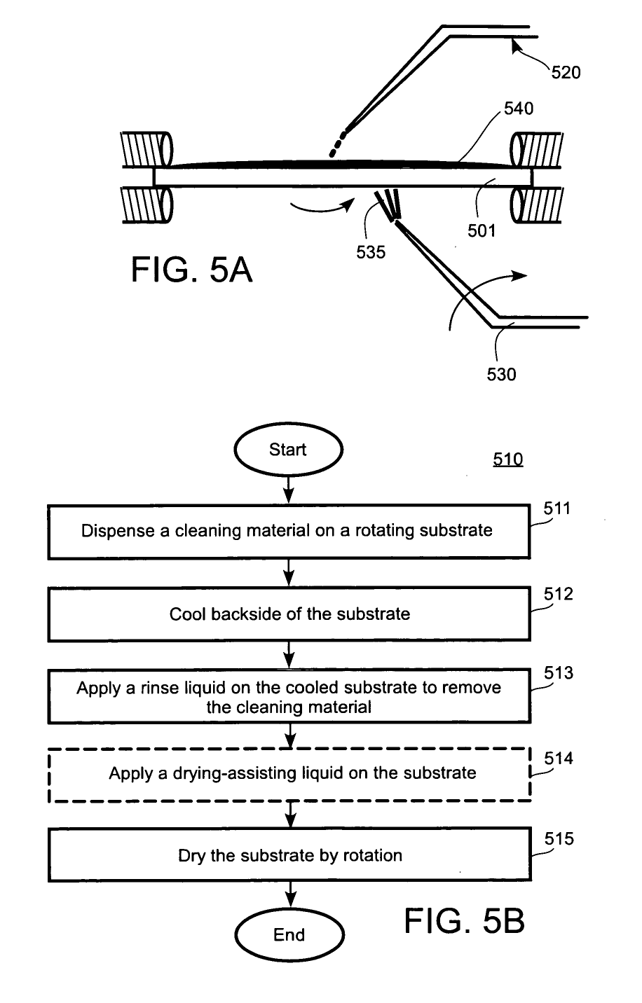

FIG. 5A shows an apparatus similar to the apparatus of FIG. 2B with backside cooling, in accordance with one embodiment of the present invention. On the front side of the substrate 501, there is a layer 540 of cleaning material, which has been applied on the substrate surface by using the rinse liquid dispenser 520. On the back side of the substrate 501, there is a cooling liquid dispenser 530, which dispenses a jet 535 of a cooling liquid on the backside of the substrate to cool the substrate 501 and the layer 540 of cleaning material. In one embodiment, the cooling liquid is dispensed while the substrate 501 is under rotation. In one embodiment, the arm of the cooling liquid dispenser 530 sweep across the bottom of the substrate in a manner similar to the sweeping of the cleaning material dispensing arm 320 of FIG. 3A. Alternatively, the backside of substrate can be cooled by a cooled gas, such as air, N₂, O₂, Ar, and He, etc.

The cooling liquid can be applied to the substrate backside during dispensing of the cleaning material or after the cleaning material is dispensed on the substrate. Dispensing the cooling liquid on the substrate backside after the cleaning material is dispensed on the substrate has the advantage of not affecting or slowing down the dispensing of the cleaning material. As discussed above, when the cleaning material is cooled, its viscosity increases, which makes the cleaning material harder to spread across the substrate surface.

In another embodiment, the substrate is cooled during the rinsing operation. The substrate can be cooled by methods and apparatus discussed above. For example, the cooling liquid can be applied on the backside of the substrate. In one embodiment, the substrate is cooled before the rinsing liquid is applied on the substrate surface. In another embodiment, the substrate is cooled before and during the rinsing operation. In another embodiment, the substrate is cooled by a combination of process operations, such as cooled during application of cleaning material and application of the rinsing liquid. In yet another embodiment, the rinsing liquid is cooled by applying cooled rinsing liquid on the substrate surface. As discussed above, when the cleaning material is cooled, the solid-like nature of the material increases, which increases the complexity of coating the substrate surface uniformly and of dispensing a high viscosity cleaning material. The “solid-like” or elastic nature of the viscoelastic cleaning material, when the cleaning material is cooled, enables particle removal without damaging the sensitive structures on the substrate surface.

FIG. 5B show a process flow 510 of removal particles from a surface of a substrate, in accordance with one embodiment of the present invention. At operation 511, a viscoelastic cleaning material is applied on a substrate that is rotating. As mentioned above, the dispense arm can be sweeping across the substrate surface. After the cleaning material is dispensed on the substrate, at operation 512, the backside of the substrate is cooled to increase the solid-like nature of the cleaning material. In one embodiment, the cooling of the substrate makes the cleaning material more “solid-like” or more elastic and is therefore easy to be removed by the rinsing liquid. In one embodiment, the cooling of the substrate can be accomplished by applying a cooling liquid on the backside of the substrate. Other embodiments are also possible. Afterwards, a rinse liquid is applied on the cooled substrate under rotation at operation 513 to remove the cooled cleaning material. In one embodiment, the rinsing liquid applies a force on the cleaning material, which is solid-like, to break and remove the cleaning material from the substrate surface. In one embodiment, the substrate is cooled during the rinsing operation. In another embodiment, the cooling of the substrate is not sufficient to make the cleaning material solid-like. The force introduced by the rinsing liquid make the cleaning material near the rinsing liquid application spot solid-like, and the rinsing liquid removes the solid-like cleaning material away from the substrate surface. Afterwards, at operation 515, the substrate is dried by rotation. In one embodiment, a drying-assisting liquid, such as IPA or IPA with N₂, is applied on the substrate at an optional operation 514, prior to operation 515.

The embodiment of process flow 510 discussed above can also be applied in an apparatus similar to apparatus 480 of FIG. 4F. The substrate support 483 can be cooled to keep the temperature of the substrate 495 and cleaning material on the surface of substrate 495 low.

### Method 3:

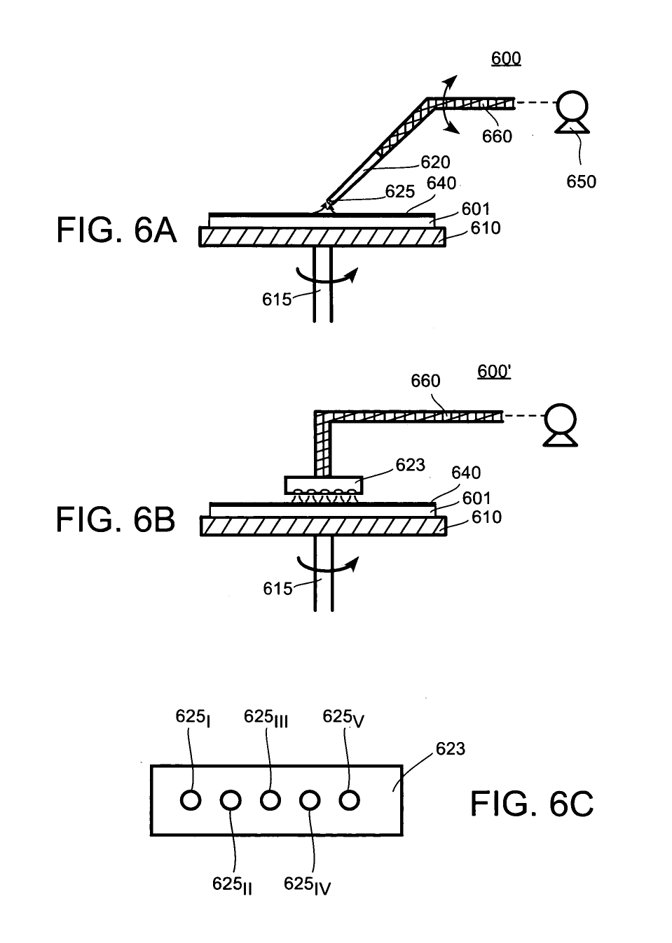

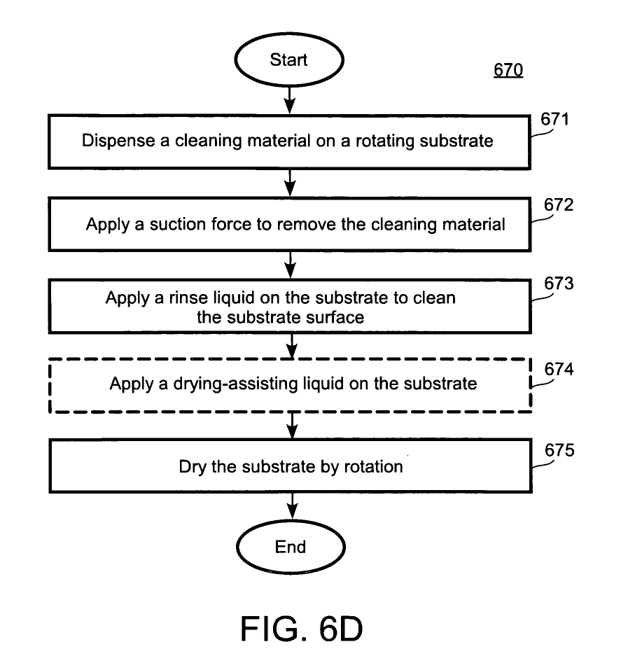

As mentioned above, applying a force on the viscoelastic cleaning material would increase the solid-like nature of the cleaning material, which facilitates removal of the cleaning material with entrapped particles from the substrate surface. Applying a suction force on the cleaning material increases the solid-like nature of the cleaning material significantly. FIG. 6A shows an apparatus 600 having a suction tube 620 attached to a handle 660, in accordance with one embodiment of the present invention. The handle 660, which has an extension of suction tube 620 inside is coupled to a vacuum pump 650. At the end of the suction tube 620, there is a suction opening 625, which is positioned close to the layer 640 of cleaning material. The layer 640 of cleaning material is on a surface of substrate 601, which is disposed on a substrate support 610. The substrate support 610 is coupled to an axle 615, which is coupled to a rotating mechanism to rotate the axle 615 and the substrate support 610. During operation, the substrate 610 rotates and the suction tube 620 sweeps across the substrate surface with the hand of the handle 660. The suction force 626 applied by the suction tube 620 at the suction opening 625 increases the solid-like nature of the cleaning material under the suction opening, which makes the cleaning material easier to be pulled away from the substrate surface. As the suction tube 620 moves across the substrate surface, the layer 640 of the cleaning material is removed from the substrate surface along with the entrapped particles on the substrate surface. After the cleaning material is removed from the substrate surface, a rinse liquid, such as DIW, is applied on the substrate surface to rinse off any residue on the substrate surface, in accordance with one embodiment of the present invention.

In one embodiment, the suction flow rate is between about 0 slm (standard liter/minute) airflow to about 1000 slm airflow. In another embodiment, the suction flow rate is between 50 slm airflow to about 500 slm airflow. In yet another embodiment, the suction flow rate is between about 100 slm airflow to about 500 slm airflow. The embodiment shown in FIG. 6A utilizes only one suction tube 620 with a single suction opening 625. Alternatively, there can be a number of suction tubes operating simultaneously to remove the cleaning material from the substrate surface. Further, the suction apparatus can be a suction head with a number of suction holes used to remove the cleaning material. FIG. 6B shows an embodiment of a suction head 623 coupled to a handle 660. FIG. 6C shows a button view of suction head 623 with suction holes, in accordance with one embodiment of the present invention. The suction head 623 gas a number of suction holes, such as suction holes 625_{I}, 625_{II}, 625_{III}, 625_{IV}, and 625_{V} lined up in a row. Description of other types of apparatus, such as a proximity head, using a suction force to remove a viscoelastic cleaning material, similar to the cleaning material described here, can be found in U.S. patent application Ser. No. 12/401,590, filed on Mar. 10, 2009, and entitled “Method of Particle Contaminant Removal.” The disclosure of the applications is incorporated herein by reference for all purposes.

FIG. 6D shows a process flow 670 for removing particles from a substrate surface, in accordance with one embodiment of the present invention. At operation 671, a viscoelastic cleaning material is applied on a substrate that is rotating. As mentioned above, the dispense arm can be sweeping across the substrate surface. After the cleaning material is dispensed on the substrate, at operation 672, a suction force is applied on the cleaning material to remove the cleaning material from the substrate surface. The suction force applied increases the solid-like nature of the cleaning material, which makes it easier to remove. Afterwards, a rinse liquid is applied on the substrate under rotation at operation 673 to remove any remaining residue. Afterwards, at operation 675, the substrate is dried by rotation. In one embodiment, a drying-assisting liquid is applied on the substrate at an optional operation 674, prior to operation 675.

Alternatively the drying operation can be assisted by applying a dry-assisting liquid such as liquid isopropyl alcohol (IPA) or a mixture of IPA and water or a dry-assisting vapor such as vapor phase IPA or a mixture of vapor phase IPA and N2 gas

The embodiment of process flow 670 discussed above can also be applied in an apparatus similar to apparatus 480 of FIG. 4F. The application of a suction force on the cleaning material can be performed in one of processing slot of an apparatus similar to apparatus 480 of FIG. 4F.

### Method 4:

As mentioned above, applying a force, or energy, on the viscoelastic cleaning material increases the solid-like response of the cleaning material. Applying a relatively low frequency acoustical force to the viscoelastic cleaning material increases the solid-like nature of the cleaning material. In one embodiment, the application of the low frequency acoustical force makes the cleaning material solid-like and easy to remove. In one embodiment, the acoustic frequency range exceeds the reciprocal of the characteristic time of the viscoelastic cleaning material. The characteristic time (or relaxation time) is the time for the cleaning material to respond to changes, such as an applied force. For example, if the viscoelastic cleaning material has a characteristic time of 1 second, the frequency of the acoustical force must exceed 1 Hz.

In one embodiment, the frequency of the acoustic energy applied on the cleaning material is between about 1 Hz to about 1000 Hz. In another embodiment, the frequency of the acoustic energy applied on the cleaning material is between about 10 Hz to about 500 Hz. In yet another embodiment, the frequency of the acoustic energy applied on the cleaning material is between about 10 Hz to about 100 Hz. When the acoustic energy is introduced at a low frequency, it has the advantage of having a larger penetration depth. Therefore, it is important to choose a frequency (or frequencies) that exceeds the reciprocal of the characteristic time and yet not too large so as to maximize penetration depth.

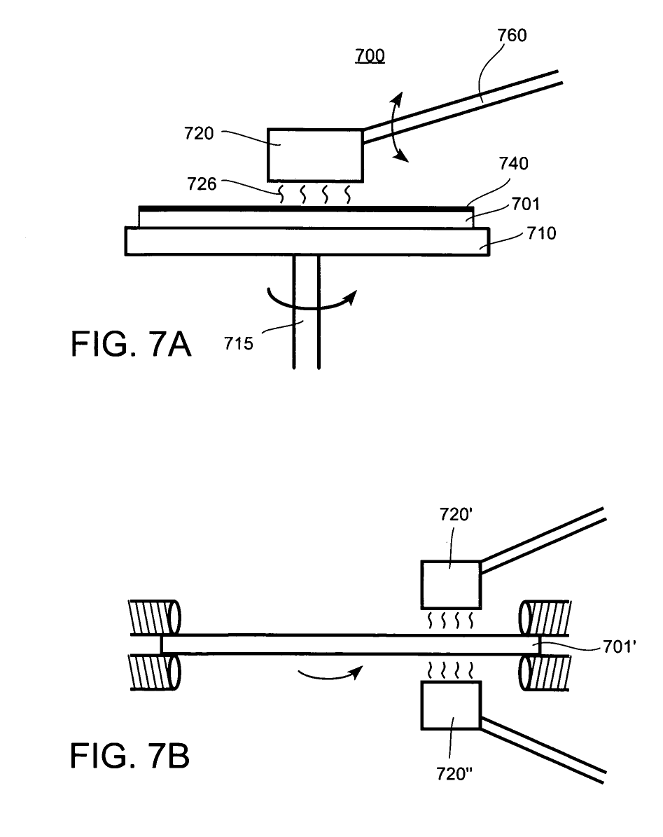

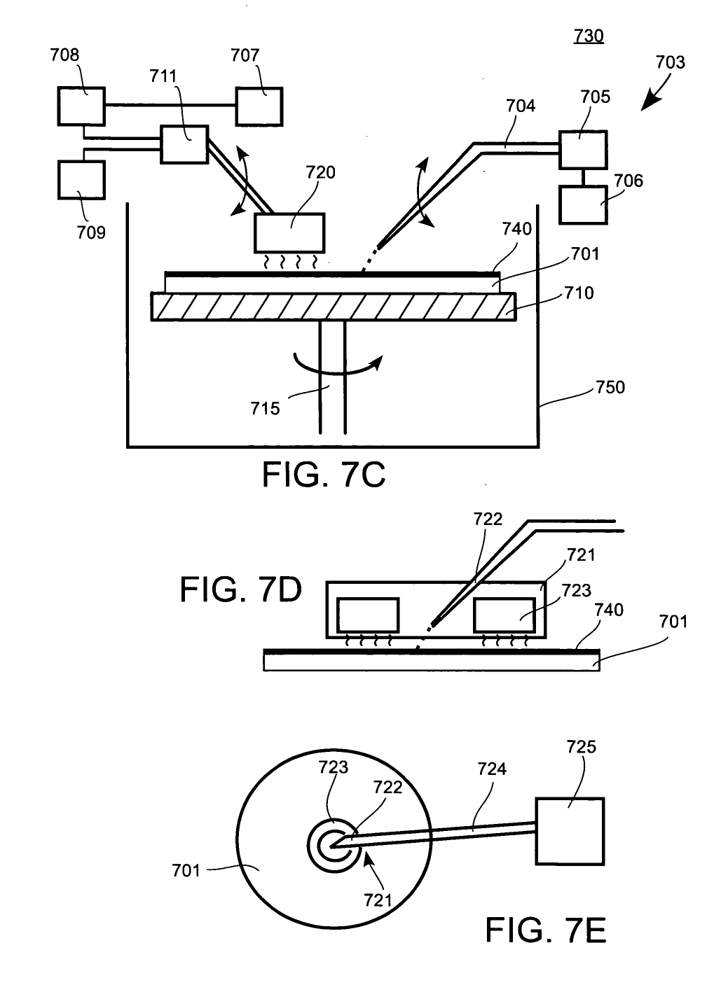

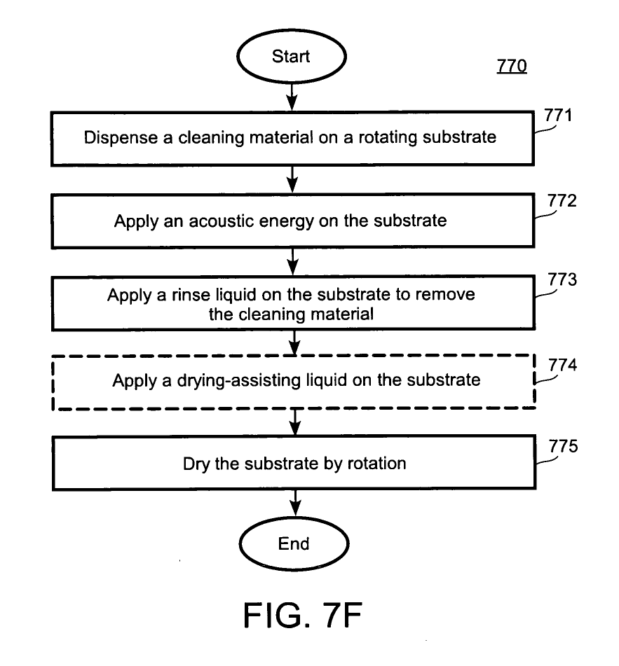

Any device that can apply acoustic energy on the substrate can be use. For example, the device (or apparatus) can be a acoustic speaker. In another embodiment, the apparatus for applying acoustic energy is an acoustic resonator plate or bar that has a unique frequency or a broad spectrum with tailored frequencies chosen to match the spectrum of the characteristic times of the viscoelastic cleaning material. In one embodiment, the acoustic resonator plate covers the entire surface of the substrate. FIG. 7A shows an embodiment of a acoustic resonator block 720 that is placed above the substrate 710, which has a layer 740 of cleaning material. The substrate 710 is disposed on a substrate support 710, which is rotated by an axle 715. The acoustic resonator block 720 emit acoustic wave 726 on the layer 740 of cleaning material. The acoustic resonator block 720 is held by an arm 760. The arm 760 moves acoustic resonator block 720 to sweep the acoustic resonator block 720 across the substrate surface, while the substrate 710 rotates. The combination of motions of the sweeping acoustic resonator block and the rotating substrate allows the acoustic resonator block 720 to transmit (or emit) acoustic energy to the entire surface of substrate 701. The acoustic energy can be applied on the cleaning material before and/or during the rinsing liquid is applied on the substrate to remove the cleaning material. The rinse liquid is applied on a cleaning material that has been and/or is being exposed to the acoustic energy, which has increased the solic-like nature of the cleaning material to make the cleaning material easy to remove. The effect of the acoustic energy on the cleaning material is only temporary; therefore, the rinsing liquid needs to be applied on the acoustic-energy-treated cleaning material soon after. Otherwise, the acoustic energy should be applied during the rinsing operation.

In one embodiment, the duration for applying the acoustic energy on the cleaning material is between about 5 seconds to about 90 seconds. In another embodiment, the duration for applying the acoustic energy on the cleaning material is between about 10 seconds to about 60 seconds. In yet another embodiment, the duration for applying the acoustic energy on the cleaning material is between about 15 seconds to about 45 seconds.

The acoustic resonance bar (or block, or plate) can be placed above and/or below the substrate during or after the cleaning material is dispensed on the substrate. If an acoustic resonance bar is placed below the substrate, the acoustic energy emitted by the acoustic resonance bar can penetrate the substrate to reach the cleaning material on the front side of the substrate. The drawing of FIG. 7A shows an acoustic resonance bar 720 placed above the front side of substrate 710. Alternatively, an acoustic resonance bar, such as acoustic resonance bar 720″ of FIG. 7B, can be placed below the backside of the substrate 701′. In another embodiment, one acoustic resonance bar 720′ can be placed above the substrate 701′ and another acoustic resonance bar 720″ can be placed below the substrate 701′ simultaneously to introduce elastic energy into the cleaning material to change the film characteristic.

The acoustic energy can be introduced before and/or during rinsing of the cleaning material. FIG. 7C shows a cleaning material rinsing system 730, in accordance with one embodiment of the present invention. Substrate 701, which has a layer of cleaning material on the surface, is supported by a substrate supported 710. The substrate supported is rotated by an axle 715. The system 730 has a rinsing liquid dispensing system 703, which includes a rinse arm 704. The rinse arm 704 dispenses the rinse liquid on the substrate surface. The rinse arm 704, which can sweep across the substrate surface, is coupled to a system 705, which provides control, mechanical force and rinsing liquid to the rinse arm 704. In one embodiment the system 705 is controlled by a separate controller 706, which controls the dispensing of the rinse liquid, such as flow rate, and the position of the rinse arm 704. In system 730, there is an acoustic resonance bar (ARB) 720. The positions (and movement) of ARB is controlled by a controller 709. The frequencies of the ARB 720 are controlled by a frequency controller 708, which is coupled to a computer 707. Computer 707 takes inputs of properties of the cleaning material, such as characteristic time(s) of the cleaning material, to determine the best frequency(ies) to increase the elastic nature of the cleaning material. As mentioned above, the frequency(ies) emitted the ARB can be a broad spectrum with tailored frequencies chosen to match the spectrum of characteristic times within the viscoelastic cleaning material. In one embodiment, controllers 708 and 709 are coupled to a control system 711 for the ARB 720.

As mentioned above, the acoustic-energy-treated cleaning material should be rinsed soon after the acoustic energy treatment to ensure that the effect of the treatment does not dissipate over time. FIG. 7D is a side view of a rinse head 721 that has a rinse liquid dispenser 722, and a ring of acoustic resonance block 723 surrounding the rinse liquid dispenser 722, in accordance with one embodiment of the present invention. The rinse liquid is sprayed on the region that is being treated with acoustic energy. FIG. 7E shows an embodiment of a top view of the rinse head 721 over the substrate 701. The rinse head 721 is held by an arm 724, which is coupled to a system 725 that supply the rinse liquid and controls the arm 724 and the rinse head 721, including the flow rate of the rinse liquid and the frequency of the acoustic resonance block 723. The arm 724 sweep across the substrate 701 while the substrate 701 spins (or rotates) around the axis of substrate 701.

FIG. 7F shows a process flow 770 for removing particles from a substrate surface, in accordance with one embodiment of the present invention. At operation 771, a viscoelastic cleaning material is applied on a substrate that is rotating. As mentioned above, the dispense arm can be sweeping across the substrate surface. After the cleaning material is dispensed on the substrate, at operation 772, an acoustic energy is applied on the cleaning material to increase the elastic nature of the cleaning material. At operation 773, a rinse liquid is applied on the substrate under rotation to remove the acoustic-energy-treated cleaning material. In one embodiment, the acoustic energy of operation 772 continues to be applied on the cleaning material during the rinsing operation. In another embodiment, there is no operation 772. Instead, the acoustic energy is applied at operation 773 only. Afterwards, at operation 775, the substrate is dried by rotation. In one embodiment, a drying-assisting liquid is applied on the substrate at an optional operation 774, prior to operation 775.

### Method 5:

When the cleaning material is dispensed on a rotating (or spinning) substrate, the cleaning material wets the substrate surface to be deposited on the substrate surface. If the substrate surface is treated first with a liquid that wets the substrate surface, the dispensing of the cleaning material could be easier and more even. The substrate undergoing a liquid pre-treatment prior to the dispensing of the viscoelastic cleaning material helps the dispensing of the viscoelastic cleaning material on the surface of the substrate. The liquid can either act to chemically condition the surface, such as controlling the hydrophilic nature of the surface or adjusting the zeta potential by potential of hydrogen ((pH), or control the initial viscoelastic interface during the radial dispense of the cleaning material by replacing the cleaning material-air interface with a cleaning material-liquid interface. Controlling the interface can improve the coverage of the viscoelastic cleaning material and can avoid some of the hydrodynamic instabilities associated with edge effects. In addition, controlling the interface also reduces the radial resistance on the substrate surface and allows the cleaning material to spread easily across the substrate surface. Further, surface pre-treatment may also remove residues that cover contaminants or particles to enable particle removal. Examples of liquid used for surface treatment include, but not limited to, DIW, APM (ammonium peroxide mixture, also called SC1), DSP (diluted sulfuric-acid peroxide mixture), SPM (sulfuric-acid peroxide mixture), DI-O3 (de-ionized water mixed with ozone), HF (hydrogen fluoride), and BOE (buffered oxide etch) solution.

It is believed that the viscoelastic cleaning material does not extensibly mix with the pre-treatment liquid. The viscoelastic cleaning material primarily replaces the pre-treatment liquid, and the pre-treatment liquid is displaced away from the substrate surface.

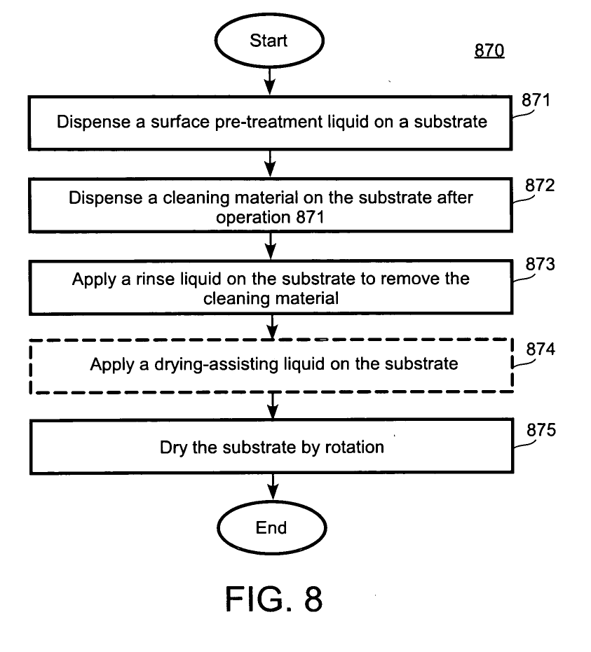

The process flow of particle removal is similar to the process flow of method 1, with the exception of adding the surface treatment with liquid operation prior to applying the cleaning material on the substrate surface. FIG. 8 shows a process flow 870 for removing particles from a substrate surface, in accordance with one embodiment of the present invention. At operation 871, a surface pre-treatment liquid is applied on the surface of a substrate to condition the substrate surface for the application of a viscoelastic cleaning material in the next operation. At operation 872, a viscoelastic cleaning material is applied on a substrate that is rotating. As mentioned above, the dispense arm can be sweeping across the substrate surface. After the cleaning material is dispensed on the substrate, at operation 773, a rinse liquid is applied on the substrate under rotation to remove the cleaning material. Afterwards, at operation 875, the substrate is dried by rotation. In one embodiment, a drying-assisting liquid is applied on the substrate at an optional operation 874, prior to operation 875.

The apparatus used for dispensing the treatment liquid is similar to the apparatus for dispensing the cleaning material, such as those described in FIGS. 3A-3C. Other types of apparatus for applying the surface pre-treatment liquid can also be used. The entire process flow can also utilize an apparatus similar to the one described in FIG. 4F. The dispensing of the treatment liquid can be conducted in one of the processing slot.

### Method 6:

Additional particle removal enhancement can be provided through additional physical forces before and/or during the rinse operation. For example, the rinse liquid can be introduced with a spray jet, which introduces a large force on the cleaning material and substrate surface. The spray jet uses aerosolized liquid droplets of rinse liquid with the assistance of a carrier gas, such as nitrogen gas (N₂). The examples of the carrier gas include, but not limited to, N₂, air, O₂, Ar, He, other types of inert gas, and a combination of the above mentioned gases. In one embodiment, the carrier gas is inert to the cleaning material. The speed of the liquid droplets can be very high, such as 100 m/s, by mixing a high ratio of N₂ with the rinse liquid.

The rinse liquid jet introduces a high inertia on the cleaning material and the substrate surface, and results in several possible effects. For example, the spray jet could increase the solid-like response of the cleaning material and permits a high degree of particle removal efficiency due to the large magnitude of the spray jet inertia. The spray jet could further provide continued particle removal after the viscoelastic cleaning material is removed since the inertia from the spray jet is capable of removing particles on its own. The spray jet could be used in 2 distinct modes depending upon the specific application. In the first mode, the spray jet inertia is maximized to provide a high degree of particle removal efficiency from both the solid-like response of the viscoelastic cleaning material and the high inertia of the spray jet. In the second mode, the spray jet inertia is reduced such that particle removal is mainly due to the solid-like response of the viscoelastic cleaning material which minimizes the risk of damaging features on the substrate. The spray jet could use a chemically inert liquid such as DIW to minimize substrate film loss or use a chemically reactive liquid such as APM to enhance particle removal efficiency by adjusting the zeta potential. Detailed description of using a spray jet to dispense a liquid can be found in U.S. patent application Ser. No. ______ (Atty. Docket No. LAM2P655), filed on ______, and entitled “Method of Particle Contaminant Removal.”

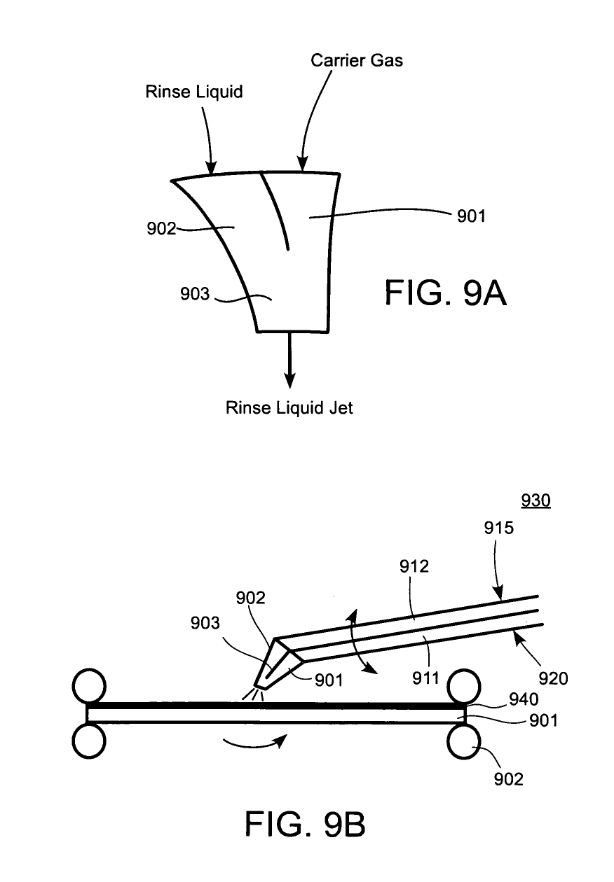

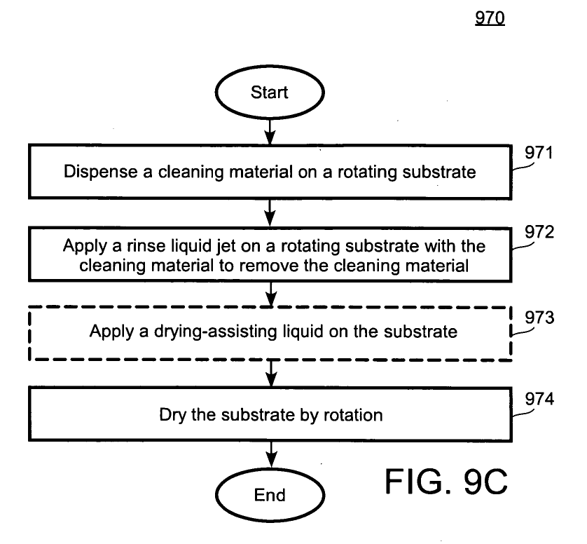

FIG. 9A shows a spray jet head 900 for introducing a rinsing liquid, in accordance with one embodiment of the current invention. The spray jet head 900 has a channel 901 for introducing a carrier gas and a channel 902 for introducing a rinse liquid. The combined flows go through channel 903 to become a spray jet of rinse liquid, which is introduced on the substrate surface with a cleaning material. In one embodiment, the rinse liquid (or rinse chemical) has a flow rate between about 100 ml/min to about 1000 ml/min. In another embodiment, the rinse liquid has a flow rate between about 50 ml/min to about 500 ml/min. In yet another embodiment, the rinse liquid has a flow rate between about 50 ml/min to about 300 ml/min. As mentioned above, the high flow of the carrier gas introduces an inertia on the cleaning material to increase the elastic nature of the cleaning material to make it easier to remove. In one embodiment, the carrier gas has a flow rate between about 1 slm (or standard liter per minute) to about 100 slm. In another embodiment, the carrier gas has a flow rate between about 5 slm to about 50 slm. In yet another embodiment, the carrier gas has a flow rate between about 5 slm to about 15 slm. The liquid droplets introduce a high inertia. In one embodiment, the liquid droplets have a velocity between about 1 m/s to about 100 m/s. In another embodiment, the liquid droplets have a velocity between about 2 m/s to about 50 n/s. In yet another embodiment, the liquid droplets have a velocity between about 2 m/s to about 20 m/s. The duration for applying the spray jet of rinse liquid is long enough to remove the cleaning material from the substrate surface along with the particles on the substrate surface. In one embodiment, the duration is between about 10 seconds to about 90 seconds. In another embodiment, the duration is between about 10 seconds to about 60 seconds. In yet another embodiment, the duration is between about 15 seconds to about 45 seconds.

FIG. 9B shows an apparatus 930 for applying a spray jet of rinsing liquid, in accordance with one embodiment of the present invention. The substrate 901 has a layer 940 of cleaning material on the surface and is held by a number of rollers 902 used for securing the substrate and to rotate the substrate. Above the substrate 901, there is a liquid spry jet apparatus 920, which includes a spray jet head 900 and a spray jet arm 915. An embodiment of the spray jet head 800 has been introduced above in FIG. 9A. The spray jet head 900 is coupled to the spray jet arm 915. In the spray jet arm 915, there are two supply lines 911 and 912 for supplying the carrier gas (911) and the rinse liquid (912) respectively. The carrier gas supply line 911 delivers carrier gas to the channel 901 of carrier gas, while the rinse liquid supply line 912 delivers the rinse liquid to the channel 901 of the rinse liquid. In one embodiment, the spray jet arm 915 is held stationary above the substrate 901 during the rinsing operation. In another embodiment, the spray jet arm 815 sweeps across the surface of substrate 901. During the rinsing operation, substrate 901 rotates.

FIG. 9C shows a process flow 970 of cleaning a substrate, in accordance with one embodiment of the present invention. At operation 971, a viscoelastic cleaning material is applied on a substrate that is rotating. As mentioned above, the dispense arm can be sweeping across the substrate surface. After the cleaning material is dispensed on the substrate, at operation 972, a spray jet of rinse liquid is applied on the substrate under rotation. As discussed above, during this operation, the force applied by the rinse liquid make the cleaning material “solid-like”, which makes it easier to be removed from the substrate surface. Afterwards, at operation 974, the substrate is dried by rotation. In one embodiment, a drying-assisting liquid, such as IPA or IPA with N₂, is applied on the substrate at an optional operation 973, prior to operation 974.

### Method 7:

As mentioned above, applying a force, or energy, on the viscoelastic cleaning material would increase the solid-like nature of the cleaning material. Method 4 above describes applying a low frequency acoustical energy to the viscoelastic cleaning material to increase the solid-like nature of the cleaning material. Alternatively, the low acoustic energy can be replaced with a megasonic or ultrasonic acoustic energy. Similarly, the megasonic or ultrasonic acoustic energy can be introduced on the front side, backside, or a combination of both front side and backside of the substrate in a manner similar to the low acoustic energy. The megasonic or ultrasonic acoustic energy can be introduced by an acoustical resonance bar (or block, or plate), or a piezoelectric transducer bar, during or after the cleaning material is dispensed on the substrate. Alternatively, the megasonic or ultrasonic acoustic energy can be introduced by more than one bars. The examples of apparatus described in Method 4 for low acoustic energy also apply to the current Method 7. Applying megasonic or ultrasonic acoustic energy increases the overall particle removal efficiency and reduces the damage threshold for sensitive structures on the substrate by lowering the energy required for particle removal. The difference between applying a low frequency acoustic energy of method 4 described above and applying a megasonic or ultrasonic acoustic energy described here is that the megasonic or ultrasonic acoustic energy could be used to assist in particle removal due to cavitation. In contrast, a low frequency acoustic energy is mainly used to increase the solid-like nature of the cleaning material. Alternatively, the megasonic or ultrasonic acoustic energy can be optimized to rely primarily on the solid-like response of the viscoelastic cleaning material and less on caviatation in order to minimize damages of the features on the substrate.

Examples of megasonic and ultrasonic frequencies include, but not limited to, 28 kHz, 44 kHz, 112 kHz, 800 kHz. 1.4 MHz, and 2 MHz. In one embodiment, the power of the megasonic or ultrasonic acoustic energy is between about 1 watt to 1000 watts. In another embodiment, the power of the megasonic or ultrasonic acoustic energy is between about 1 watt to 300 watts. In yet another embodiment, the power of the megasonic or ultrasonic acoustic energy is between about 10 watts to 300 watts. In one embodiment, the duration for applying the megasonic or ultrasonic acoustic energy is between about 10 seconds to about 90 seconds. In another embodiment, the duration for applying the megasonic or ultrasonic acoustic energy is between about 10 seconds to about 60 seconds. In yet another embodiment, the duration for applying the megasonic or ultrasonic acoustic energy is between about 15 seconds to about 45 seconds.

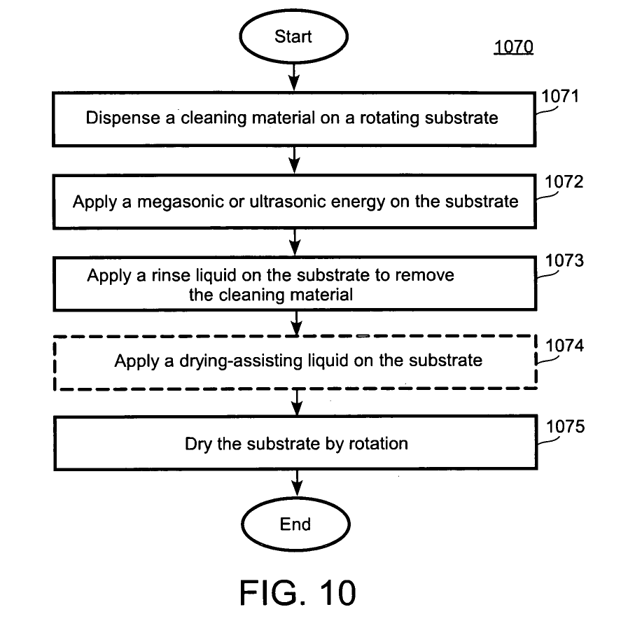

FIG. 10 shows a process flow 1070 for removing particles from a substrate surface, in accordance with one embodiment of the present invention. At operation 1071, a viscoelastic cleaning material is applied on a substrate that is rotating. As mentioned above, the dispense arm can be sweeping across the substrate surface. After the cleaning material is dispensed on the substrate, at operation 1072, a megasonic or ultrasonic energy is applied on the cleaning material to increase the solid-like nature of the cleaning material. In one embodiment, the acoustic energy is megasonic acoustic energy. In another embodiment, the acoustic energy is ultrasonic acoustic energy. In yet another embodiment, the megasonic or ultrasonic acoustic energy also assist in particle removal by cavitation. At operation 1073, a rinse liquid is applied on the substrate under rotation to remove the acoustic-energy-treated cleaning material. In one embodiment, the megasonic or ultrasonic acoustic energy is applied during the rinsing operation. Afterwards, at operation 1075, the substrate is dried by rotation. In one embodiment, a drying-assisting liquid, such as IPA or IPA with N₂, is applied on the substrate at an optional operation 1074, prior to operation 1075.

### Method 8:

As described above, increasing the elastic nature of the cleaning material makes the cleaning material easier to remove after it's dispensed on the substrate surface to remove particles from the substrate surface. In one embodiment, a shear force is introduced on the cleaning material on the substrate to increase the elastic nature of the cleaning material by oscillating the substrate, which means to rotate the substrate back and forth. The oscillation of the substrate introduces a shear force on the cleaning material. In one embodiment, the oscillation is performed during the dispensing of the cleaning material. In another embodiment, the oscillation is introduced after the dispense of the cleaning material, but before the rinse operation. In yet another embodiment, the oscillation is introduced during the rinse operation.

The oscillatory frequency needs to be higher than the inverse of the longest characteristic time of the viscoelastic cleaning material. For example, if the longest characteristic time of the cleaning material is 1 second, the oscillatory frequency is higher than 1 Hz. In one embodiment, the oscillatory frequency is between about 1 Hz to about 1000 Hz. In another embodiment, the oscillatory frequency is between about 10 Hz to about 500 Hz. In yet another embodiment, the oscillatory frequency is between about 20 Hz to about 200 Hz.

The apparatus described in FIGS. 3A-3C, and 4F for securing and rotating a substrate can be used to oscillate the substrate. 1 show an embodiment of a top view of a substrate 1001 under oscillation of degree A. Substrate 1101 starts at position of 0 degree and is oscillated to A/2 degree position and returns to 0 degree position, and then being oscillated to −A/2 degree position. Overall, substrate 1101 is oscillated for A degree. In one embodiment, the oscillatory amplitude (degree of oscillation) is between about 0.1 degree to about 180 degrees. In another embodiment, the oscillatory amplitude is between about 0.5 degree to about 90 degrees. In yet another embodiment, the oscillatory amplitude is between about 1 degree to about 30 degree.

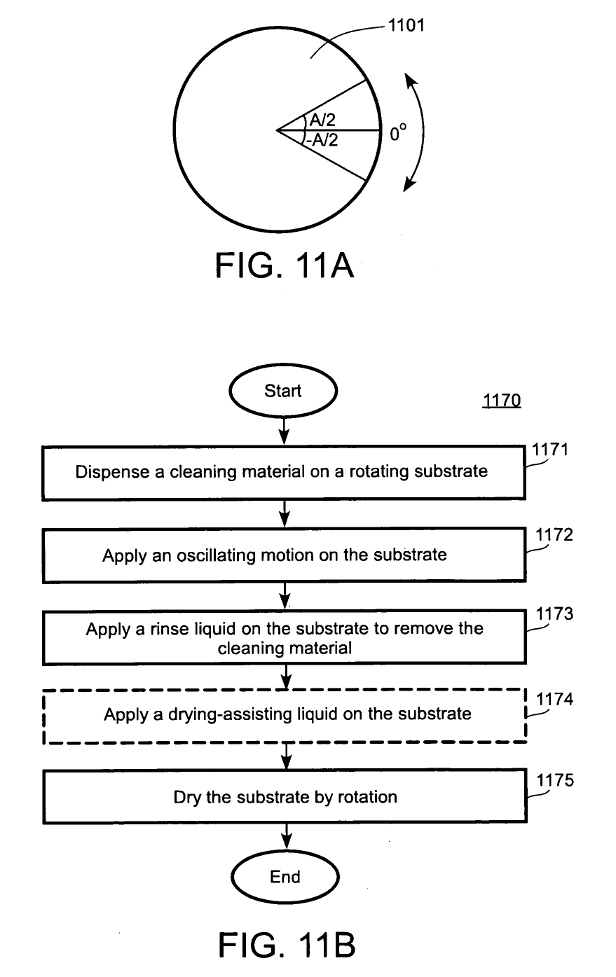

FIG. 11B shows a process flow 1170 for removing particles from a substrate surface, in accordance with one embodiment of the present invention. At operation 1171, a viscoelastic cleaning material is applied on a substrate that is rotating. As mentioned above, the dispense arm can be sweeping across the substrate surface. After the cleaning material is dispensed on the substrate, at operation 1172, an oscillating motion is applied on the cleaning material to increase the solid-like nature of the cleaning material. At operation 1173, a rinse liquid is applied on the substrate under rotation to remove the cleaning material. Afterwards, at operation 1175, the substrate is dried by rotation. In one embodiment, a drying-assisting liquid is applied on the substrate at an optional operation 1174, prior to operation 1175.

Different elements of the methods described above can be mixed together to achieve the best particle removal results. For example, a substrate applied with a cleaning material can be cooled and be pulled away from the substrate surface by a suction force. Alternatively, a substrate applied with a cleaning material can be cooled and be sprayed with a rinse liquid jet to remove the cleaning material. Accessing the solid-like nature of the cleaning material allows the viscoelastic cleaning material with entrapped particles to be more readily removed from the substrate surface.

The viscoelastic cleaning materials, apparatus, and methods discussed above have advantages in cleaning patterned substrates with fine features without damaging the features. The viscoelastic cleaning materials are fluidic, either in liquid phase, or in liquid/gas phase (foam), and deform around device features; therefore, the cleaning materials do not damage the device features. The viscoelastic cleaning materials in liquid phase can be in the form of a liquid, a sol, or a gel. The viscoelastic cleaning materials containing one or more polymeric compounds with large molecular weights capture the contaminants on the substrate. In addition, the viscoelastic cleaning materials entrap the contaminants and do not return the contaminants to the substrate surface. In one embodiment, the one or more polymeric compounds with large molecular weight form long polymer chains. In one embodiment, the one or more polymeric compounds are cross-linked to form a network of polymers. The viscoelastic cleaning materials with one or more polymeric compounds show superior capabilities of capturing and entrapping contaminants, in comparison to conventional cleaning materials.

The viscoelastic cleaning material described above is substantially free of non-deformable particles (or abrasive particles), before it is applied on the substrate surface to remove contaminants or particles from the substrate surface. Non-deformable particles are hard particles, such as particles in a slurry or sand, and can damage fine device features on the patterned substrate. During the substrate cleaning process, the cleaning material would collect contaminants or particles from the substrate surface. However, no non-deformable particles have been intentionally mixed in the cleaning material before the cleaning material is applied on the substrate surface for substrate cleaning.

Although the discussion above is centered on cleaning contaminants from patterned wafers, the cleaning apparatus and methods can also be used to clean contaminants from un-patterned or planar wafers. In addition, the exemplary patterns on the patterned wafers discussed above are protruding lines, such as polysilicon lines or metal lines. However, the concept of the present invention can apply to substrates with recessed features. For example, recess vias after CMP can form a pattern on the wafer and a most suitable design of channels can be used to achieve best contaminant removal efficiency.

A substrate, as an example used herein, denotes without limitation, semiconductor wafers, hard drive disks, optical discs, glass substrates, and flat panel display surfaces, liquid crystal display surfaces, etc., which may become contaminated during manufacturing or handling operations. Depending on the actual substrate, a surface may become contaminated in different ways, and the acceptable level of contamination is defined in the particular industry in which the substrate is handled.

Although a few embodiments of the present invention have been described in detail herein, it should be understood, by those of ordinary skill, that the present invention may be embodied in many other specific forms without departing from the spirit or scope of the invention. Therefore, the present examples and embodiments are to be considered as illustrative and not restrictive, and the invention is not to be limited to the details provided therein, but may be modified and practiced within the scope of the appended claims.

What is claimed is:

1. A method of removing particles from a surface of a substrate, comprising:
dispensing a layer of a cleaning material on the surface of the substrate, wherein the substrate is rotated by a substrate support, and wherein the cleaning material is a viscoelastic solution which includes a polymeric compound, the polymeric compound being soluble in a cleaning solution to form the cleaning material, the cleaning material captures and entraps at least some of the particles from the surface of the substrate; and
dispensing a rinsing liquid on the layer of the cleaning material on the surface of the substrate to remove the layer of cleaning material, wherein an energy is applied on the cleaning material during or prior to dispensing the rinsing liquid on the layer of the cleaning material, wherein the energy applied increases a solid-like response of the cleaning material to facilitate removal of the cleaning material from the substrate surface, and wherein the at least some of the particles that are entrapped by the cleaning material are removed along with the cleaning material.

2. The method of claim 1, wherein the energy is introduced by a force applied on the layer of the cleaning material during the dispensing of the rinsing liquid, wherein dispensed rinsing liquid removes the layer of the cleaning material.

3. The method of claim 1, wherein the substrate and the cleaning material are cooled to a temperature between about 0° C. to about 30° C. prior to and during dispensing the rinsing liquid, and wherein cooling of the cleaning material increases the solid-like response of the cleaning material to make the cleaning material and the entrapped particles easier to remove by the dispensed rinsing liquid.

4. The method of claim 1, wherein the energy introduced is applied by a suction force on the layer of the cleaning material, and wherein the suction force pulls the layer of the cleaning material away from the surface of the substrate to remove the cleaning material and the entrapped particles

5. The method of claim 1, wherein a surface pre-treatment liquid is applied on the surface of the substrate prior to the layer of the cleaning material is dispensed on the surface of the substrate.

6. The method of claim 1, wherein the energy introduced in a low frequency acoustic energy whose frequency is greater than a reciprocal of a characteristic time of the cleaning material, and wherein the frequency is between about 10 Hz to about 500 Hz.

7. The method of claim 1, wherein the rinsing liquid is dispensed on the layer of the cleaning material by a spray jet, and wherein the spray jet introduced the energy applied on the cleaning material by the force of the spray jet.

8. The method of claim 1, wherein the energy introduced in a megasonic or ultrasonic acoustic energy whose frequency is greater than a reciprocal of a characteristic time of the cleaning material.

9. The method of claim 1, wherein the energy is introducing by oscillating the substrate around an axis of the substrate during or after the layer of the cleaning material is dispensed on the surface of the substrate.

10. The method of claim 1, wherein the polymeric compound is selected from the group consisting of acrylic polymers, such as polyacrylamide (PAM), polyacrylic acid (PAA), such as Carbopol 940™ and Carbopol 941™, copolymers of PAM and PAA, poly-(N,N-dimethyl-acrylamide) (PDMAAm), poly-(N-isopropyl-acrylamide) (PIPAAm), polymethacrylic acid (PMAA), polymethacrylamide (PMAAm), polyimines and oxides, such as polyethylene imine (PEI), polyethylene oxide (PEO), polypropylene oxide (PPO), vinyl polymers, such as polyvinyl alcohol (PVA), polyethylene sulphonic acid (PESA), polyvinylamine (PVAm), polyvinyl-pyrrolidone (PVP), poly-4-vinyl pyridine (P4VP), cellulose derivatives, such as methyl cellulose (MC), ethyl-cellulose (EC), hydroxyethyl cellulose (HEC), carboxymethyl cellulose (CMC), polysaccharides, such as acacia, agar and agarose, heparin, guar gum, xanthan gum, and proteins such as albumen, collagen, and gluten.

11. The method of claim 1, wherein the rinse liquid is de-ionized water.

12. The method of claim 3, wherein the substrate and the cleaning material are cooled by spraying cold water on the backside of the substrate or substrate support.

13. The method of claim 5, wherein the pre-treatment liquid is selected from a group consisting of de-ionized water (DIW), APM (ammonium peroxide mixture), DSP (diluted sulfuric-acid peroxide mixture), SPM (sulfuric-acid peroxide mixture), DI-O3 (de-ionized water mixed with ozone), HF (hydrogen fluoride), and BOE (buffered oxide etch) solution.

14. The method of claim 7, wherein the rinse liquid is mixed with a carrier gas in the spray jet, and wherein the carrier gas is selected from a group consisting of N₂, air, O₂, Ar, He, other types of inert gas, and a combination of the above mentioned gases.

15. The method of claim 8, wherein the frequency of the megasonic or ultrasonic acoustic energy is selected from a group consisting of about 28 kHz, about 44 kHz, about 112 kHz, about 800 kHz, about 1.4 MHz, and about 2 MHz.

16. The method of claim 8, wherein the oscillatory frequency is greater than a reciprocal of a characteristic time of the cleaning material.

17. The method of claim 1, further comprising:
applying a drying-assisting liquid on the surface of the substrate after the layer of the cleaning material has been removed; and
drying the surface of the substrate after the dry-assisting liquid has been applied by rotating the substrate.

18. The method of claim 1, wherein the drying-assisting liquid is isopropyl alcohol (IPA), a mixture of IPA and water, a vapor phase IPA, or a mixture of vapor phase IPA and an inert gas.

19. A method of removing particles from a surface of a substrate, comprising:
dispensing a layer of a viscoelastic cleaning material on the surface of the substrate, wherein the substrate is rotated by a substrate support, and wherein the viscoelastic cleaning material captures and entraps at least some of the particles from the surface of the substrate; and
dispensing a rinsing liquid on the layer of the cleaning material on the surface of the substrate to remove the layer of cleaning material, wherein an energy is applied on the cleaning material during or prior to dispensing the rinse liquid on the layer of the cleaning material, wherein the energy applied increases a solid-like response of the cleaning material to facilitate removal of the cleaning material from the substrate surface, and wherein the at least some of the particles that are entrapped by the cleaning material are removed along with the cleaning material.

20. A method of removing particles from a surface of a substrate in an apparatus having a number of processing slots, comprising:
moving the substrate to a first processing slot of the apparatus by a substrate support, wherein the first processing slot of the apparatus is separated from the processing slots below the first processing slot by the substrate support;
dispensing a layer of a viscoelastic cleaning material on the surface of the substrate, wherein the substrate is rotated by a substrate support, and wherein the viscoelastic cleaning material captures and entraps at least some of the particles from the surface of the substrate;
moving the substrate to a second processing slot of the apparatus by the substrate support, wherein the second processing slot of the apparatus is separated from the processing slots below the second processing slot by the substrate support; and
dispensing a rinsing liquid on the layer of the cleaning material on the surface of the substrate to remove the layer of the viscoelastic cleaning material, wherein an energy is applied on the cleaning material during or prior to dispensing the rinse liquid on the layer of the cleaning material, wherein the energy applied increases a solid-like response of the cleaning material to facilitate removal of the cleaning material from the substrate surface, and wherein the at least some of the particles that are entrapped by the cleaning material are removed along with the cleaning material.

21. The method of claim 20, further comprising:
moving the substrate to a third processing slot of the apparatus by the substrate support, wherein the third processing slot of the apparatus is separated from the processing slots below the second processing slot by the substrate support or the backside of the substrate support becomes an exterior of the apparatus;
applying a drying-assisting liquid on the surface of the substrate that has been removed of the layer of the viscoelastic cleaning material, wherein the substrate spins when the drying-assisting liquid is rotated during the drying-assisting liquid is being applied; and
drying the substrate by spinning the substrate after the drying-assisting liquid has been applied.

22. The method of claim 20, wherein the backside of the substrate support is sprayed with a cold liquid to lower the temperature of the substrate and the layer of cleaning material before and during the rinse liquid is applied on the layer of the viscoelastic cleaning material, and wherein lowering the temperature of the layer of the viscoelastic cleaning material increases the elastic nature of the cleaning material.

24. The method of claim 20, wherein the energy is applied by a vacuum suction on the layer of the viscoelastic cleaning material prior to dispensing the rinse liquid when the substrate is in the first or the second processing slot.

25. The method of claim 20, wherein the rinsing liquid is dispensed by a spray jet, and the energy is applied on the layer of the viscoelastic cleaning material by the spray jet.

26. The method of claim 20, wherein the energy is an acoustic energy with a frequency greater than a reciprocal of a characteristic time of the viscoelastic cleaning material.
